(19) United States
(12) Patent Application Publication
(10) Pub. No.: US 2006/0268825 A1
(43) Pub. Date: Nov. 30, 2006

(54) Method and arrangement for resource allocation in a radio communication system using pilot packets

(76) Inventor: Erik Westerberg, Enskede (SE)

Correspondence Address: NIXON & VANDERHYE, PC, 901 NORTH GLEBE ROAD, 11TH FLOOR, ARLINGTON, VA, 22203, US

(21) Appl. No.: 10/547,803

(22) PCT Filed: Mar. 5, 2004
(86) PCT No.: PCT/SE04/00322

§ 371 Date: Sep. 6, 2005

(30) Foreign Application Priority Data
Mar. 6, 2003 (SE) 0300622.8

(51) Int. Cl. H04L 12/66

(52) U.S. Cl. 370/352

(57) ABSTRACT

In the present invention, a pilot packet is created as a response to an indication that a data stream is to take place within a short while. The small pilot packet shall be transported from the sender to the same receiver as the receiver of the subsequent data stream a short time before the first data packet is sent to the receiver. The pilot packet will trig the allocation of transmission resources, typically radio links, along its signalling path. When the data packets are transported along the same path a short time later, the transmission resources are already allocated according to conventional dynamic allocation schemes.

### TECHNICAL FIELD

The present invention relates in general to radio communication systems allowing data packet transferring, and in particular to such systems having applications with strict latency requirements.

### BACKGROUND

In radio systems for data communication, a new generation of end-user applications is emerging with latency requirements well below one second. One example is the application “Push To Talk” (PTT). Other applications are voice over IP, “Push To Video” and interactive gaming.

In radio communication systems radio resources are allocated to a radio unit. Once there are allocated radio resources, the radio unit can transmit and/or receive user data across the radio interface. However, there are too many potential users to allow for each one to have radio resources allocated continuously, even during inactivity periods.

Therefore, most radio communication systems use dynamic allocation of radio resources to the radio units. This implies that a radio resource is temporarily allocated to a radio unit only during the time periods where data transfers are requested. During intermediate periods, the radio units are brought into an idle mode.

There are several good reasons why dynamic allocation of radio resources is a core part in virtually all radio communication standards. Two of the most important reasons are radio resource economics and battery considerations.

The radio resources are one of the main bottlenecks in most radio communication systems. With dynamic radio-resource allocation, the available radio resources do only have to be sufficient for the number of radio units being active simultaneously. Hence, a multitude of radio units can be served with a minimum of radio resources.

Moreover, the radio unit typically has to use more battery resources while having allocated radio resources than when it is in idle mode. Idle mode is used in the meaning of not having allocated radio resources. Hence, with intelligent use of dynamic radio-resource allocation, the battery standby time of the radio unit can be increased. In packet data radio systems like GPRS (General Packet Radio Service), EDGE (Enhanced Data rates for Global system for mobile communications Evolution) and W-CDMA (Wideband Code Division Multiple Access), a radio resource is allocated dynamically in a so-called Temporary Block Flow (TBF). The TBFs take a few hundred milliseconds to allocate.

The main drawback of dynamic allocation of radio resources is therefore that it requires some signaling between the network and the radio unit when allocating the radio resources. This induces a set-up time for allocating the radio resources, which adds to the delay of the user-data that is to be transmitted across the radio link.

One attempt in prior art to reduce the above drawback is to use dynamic allocation of radio-resources in combination with a delayed de-allocation of the radio resources. As an example, in GPRS, the TBF is often maintained for 1-2 seconds after the transmission of data has ceased. If additional data is to be transmitted within this delay period, the TBF (radio resources) are already allocated and the new data can be transmitted without the additional TBF set-up delay.

A second approach in prior art uses intelligent guesses for pre-allocating radio resources in advance. As one example, in a TCP/IP (Transmission Control Protocol/Internet Protocol) transfer, the reception in the client device of an IP packet typically triggers the sending of the corresponding TCP acknowledge message. In this way, the network may choose to allocate radio resources to the radio unit for the uplink already during the transfer of an IP packet downlink. This is performed in anticipation of the sending of the corresponding TCP acknowledgement message from the radio unit. Obviously, this approach requires a predictable and consistent traffic pattern and a good knowledge thereof. Furthermore, a separate resource allocation procedure has to be employed.

### SUMMARY

The problem with prior art systems is that the use of dynamic allocation of radio resources induces an additional delay in the transfer of user-data by the fact that it takes a finite time to allocate the radio resources. The prior art solutions to mitigate such effects fail in situations where the traffic pattern is unpredictable and when there are gaps in the traffic flow that are larger than 1-2 seconds.

An object of the present invention is thus to provide methods and devices for removing or reducing the latency for the initial packet/packets in a data stream. A further object of the present invention is to provide such methods and devices operable for applications having strict latency requirements. Yet a further object of the present invention is to provide methods and devices, which are compatible with the present types of dynamic allocation procedures.

The above objects are achieved by methods and devices according to the enclosed patent claims. In general words, a pilot packet is created as a response to an indication that a data stream is to take place within a short while. The small pilot packet shall be transported from the sender to the same receiver as the receiver of the subsequent data stream a short time before the first data packet is sent to the receiver. The pilot packet will trig the allocation of radio resources along its signalling path. When the data packets are transported along the same path a short time later, the radio resources are already allocated according to conventional dynamic allocation schemes.

One of the advantages with the present invention is that it enables the communication system to support applications with 200-300 ms lower latency requirements than in prior art.

### BRIEF DESCRIPTION OF THE DRAWINGS

The invention, together with further objects and advantages thereof, may best be understood by making reference to the following description taken together with the accompanying drawings, in which:

FIG. 1 is a block diagram schematically illustrating an embodiment of a communications system in which the present invention advantageously is implemented;

FIG. 2 is a signalling diagram illustrating the one-way latency of an IP packet in case no radio resources are allocated at the time of transmission;

FIG. 3 is a signalling diagram illustrating the one-way latency of an IP packet in case radio resources are allocated at the time of transmission;

FIG. 4 is a signalling diagram illustrating the latency of PTT voice packets according to prior art;

FIG. 5 is a signalling diagram illustrating the latency of PTT voice packets according to an embodiment of the present invention;

FIG. 6 is a block diagram illustrating an embodiment of a device according to the present invention;

FIG. 7 is a block diagram schematically illustrating another embodiment of a communications system in which the present invention advantageously is implemented;

FIG. 8 is a block diagram schematically illustrating yet another embodiment of a communications system in which the present invention advantageously is implemented;

FIG. 9 is a block diagram illustrating an embodiment of a device according to the present invention, suitable for a system as in FIG. 8; and

FIG. 10 is a flow diagram illustrating an embodiment of a method according to the present invention.

### DETAILED DESCRIPTION

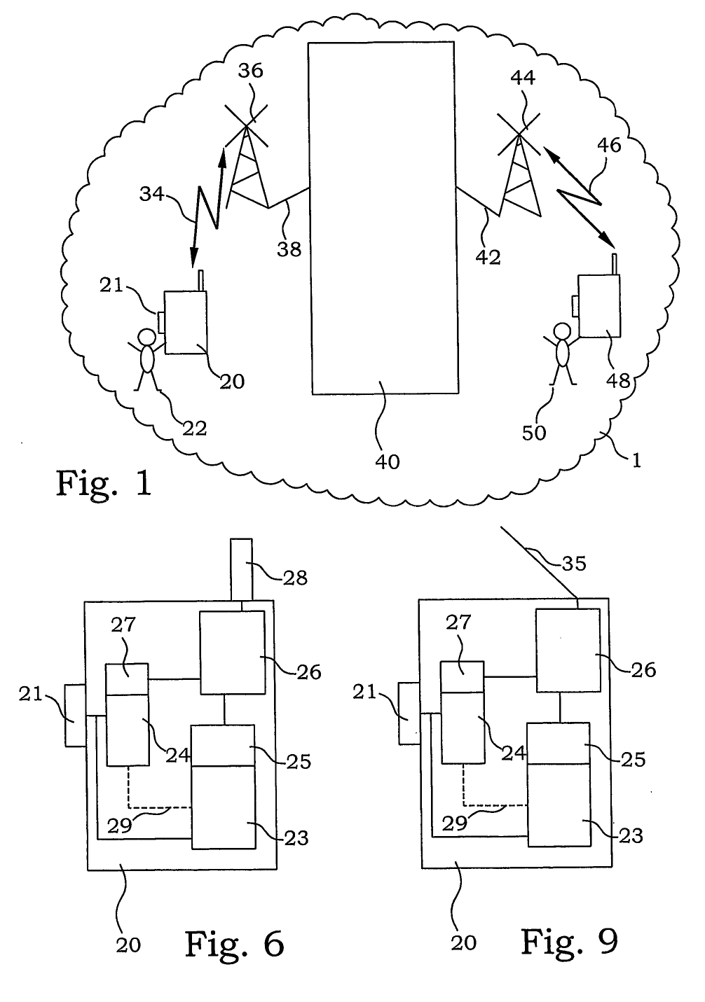

FIG. 1 illustrates a typical wireless communications system 1, in which the present invention can be utilised. A first client 22, being a subscriber of “Push To Talk” services of the wireless communications system 1, has a first radio unit 20. The first radio unit 20 is connected to a first base station 36 via a first radio link 34. The first base station 36 is connected by a first core network link 38 to a core network 40 of the wireless communications system 1. The first core network link 38 can according to different prior-art techniques be implemented by e.g. radio, fibre or wire. The structure and operation of the core network 40 is known from prior-art, and since it is not essential for the understanding of the present invention, it is not further discussed.

Similarly, at a receiving side, a second base station 44 is connected by a second core network link 42. The second base station 44 is connected to a second radio unit 48 via a second radio link 46. Finally, a second client 50 is within interaction distance from the second radio unit 48, ready to receive any speech signals.

When the first client 22 wants to talk with the second client 50, the first client 22 pushes a talk button 21 to activate the “Push To Talk” functionalities in the first radio unit 20. Thereafter, the first client 22 begins to talk. The first radio unit 20, creates data packets corresponding the speech, and transmits the packets to the receiving second radio unit 48 via the wireless communication system 1.

As discussed above, the use of TBF efficiently removes any additional latency for the majority of transported data packets. However, the TBF set-up time for the first IP packet in a stream, which adds to the latency of any data packet that is to be transported through the system, can not be avoided.

For illustrating the timing issues in dynamic allocation of radio resources, let us for explanatory reasons consider the radio communication system 1 of FIG. 1 being a GPRS system, as an example. In packet idle mode, a GPRS radio unit 20, 48 listens to a common broadcast channel. When user data is to be sent from the network 36, 40, 44 to the GPRS radio unit 20, 48, the system allocates radio resources 34, 46 in the form of a TBF to the radio unit 20, 48. In GPRS, the TBF is a radio resource that consists of a GPRS/GSM physical radio channel, i.e. frequency and timeslot, in combination with a unique logical address that the radio unit 20, 48 shall use. The set-up time is different in different systems. In GPRS it is between 120 and 300 ms depending on choice of design. This additional delay adds to the latency of any data packet that is to be transported through the system.

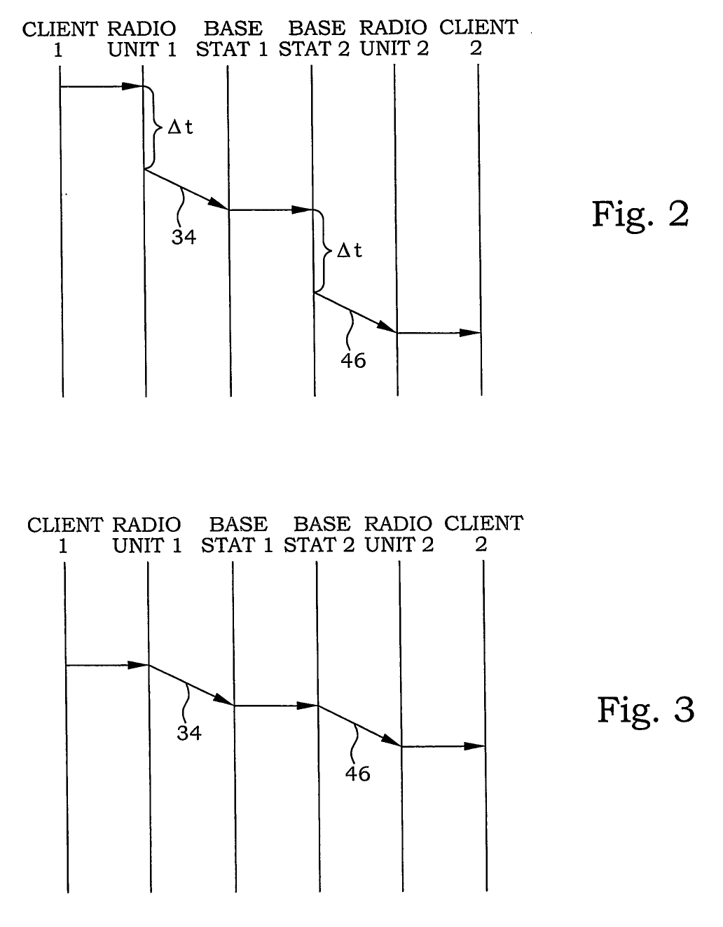

A simple signalling diagram is illustrated in FIG. 2. In this figure, the one-way latency of an IP packet is illustrated, in case no radio resources 34, 46 were allocated at the time of transmission. The Δt=160 ms between the arrival and departure of the IP packet in radio unit 1 represents the 160 ms set-up time for the needed uplink TBF 34 in GPRS. Similarly, the Δt=160 ms the IP packet spends in Base Station 2 is the corresponding set-up time for the downlink 46 TBF in the receiving part of the system. Note that the illustration is not in proper scale.

Once the radio resources are allocated, i.e. the TBF is established in case of GPRS, the radio resources can be used for transferring user data. In this GPRS example, data can be transferred from radio unit 1 to the radio unit 2. Such a situation is illustrated in FIG. 3 as a signalling diagram. The diagram shows the one-way latency of an IP packet in case radio resources 34, 46 are already allocated at the time of transmission. The latency is in this case 320 ms shorter than in the example in FIG. 2.

When the transmission is judged to be complete, the TBF is de-allocated. The radio units return to packet idle mode and resumes listening to the common broadcast channel.

While less important for many applications, the extra delay induced by the radio-resource set-up time is indeed a substantial problem in delay sensitive applications with latency requirements below 1000 ms, like interactive gaming, Voice on IP, Push To Video and PTT. In e.g. PTT, where IP packets carry voice speech frames, users are very delay sensitive.

Push To Talk is, as mentioned above, one example of an application where prior art fails. In short, Push To Talk (PTT) is a Communication-Radio like application. One user pushes a talk-button on the radio unit and then talks. The voice is recorded in 20 ms speech frames. A set of speech frames, typically ten, is put in one IP packet. The IP packet is then sent across the radio interface to the receiver. The receiver is possibly also using a radio unit elsewhere in the system. Once in the receiver, the IP packet is opened, the speech frames recovered and the voice played in the recipient handset. Characteristic to PTT is that stringent latency requirements for transport of the IP packets are defined. In a first version of PTT, the latency requirement is around 1000 ms. However, it can be expected that in enhanced versions, the latency requirements for the IP packet transport will be as low as 400 ms.

Furthermore, PTT is an “always on-line” service. Hence, after minutes of silence any user can push the talk button and start to talk. The resulting IP packets have to be transported within the stipulated latency requirement.

In the PTT scenario, prior art fails. While working well for all subsequent IP packets in a voice stream, prior art is incapable of avoiding the radio-resource allocation delay for the first voice packet in the stream.

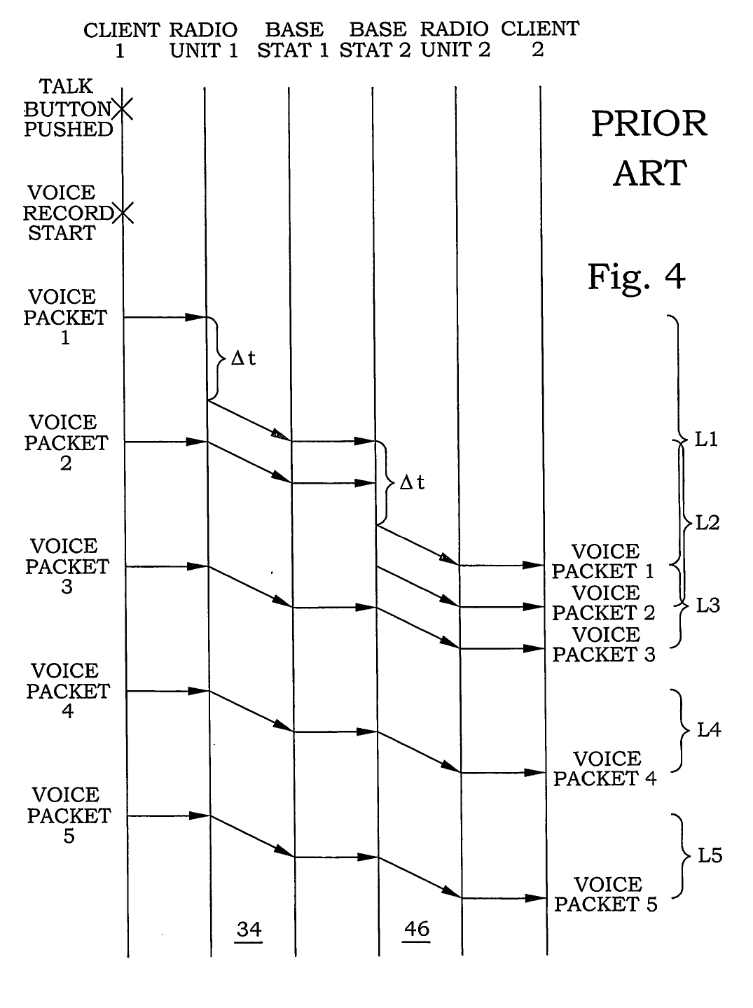

PTT built on prior art is illustrated in FIG. 4. First, the talk button is pushed, indicated by a cross at the time line of client 1. Then, the recording of the voice starts some short time afterwards. After 200 ms sampling and additional time for handling the voice packet, a first voice packet is ready t be sent. As can be seen, the first voice packet will have larger latency L1 than subsequent voice packets in a voice stream L2-L5. This is the result of that the first packet will have to await the allocation of radio resources (TBF allocation) first for the uplink 34 transfer from radio unit 1 to the network and then for the downlink 46 transfer from the network to the second radio unit. In PTT, IP packets are sent with 200 ms intervals for as long as voice frames are generated. Prior art will be able to maintain the radio resources in between IP packets in the same voice stream which enables voice packets 2, . . . , n to have lower latency L2-L5. In the figure, voice packet 3 and subsequent voice packets have reached the minimum latency. The latency of voice packet 1 is in this example 320 ms longer than the latency for voice packet 3. The extra delay for voice packet 1 is due to the time needed to allocate radio resources across the two radio interfaces. However, the general service latency has to adapt to the worst packet latency, i.e. the latency of the first packet. Hence, the first-packet delay is a significant problem in services like PTT.

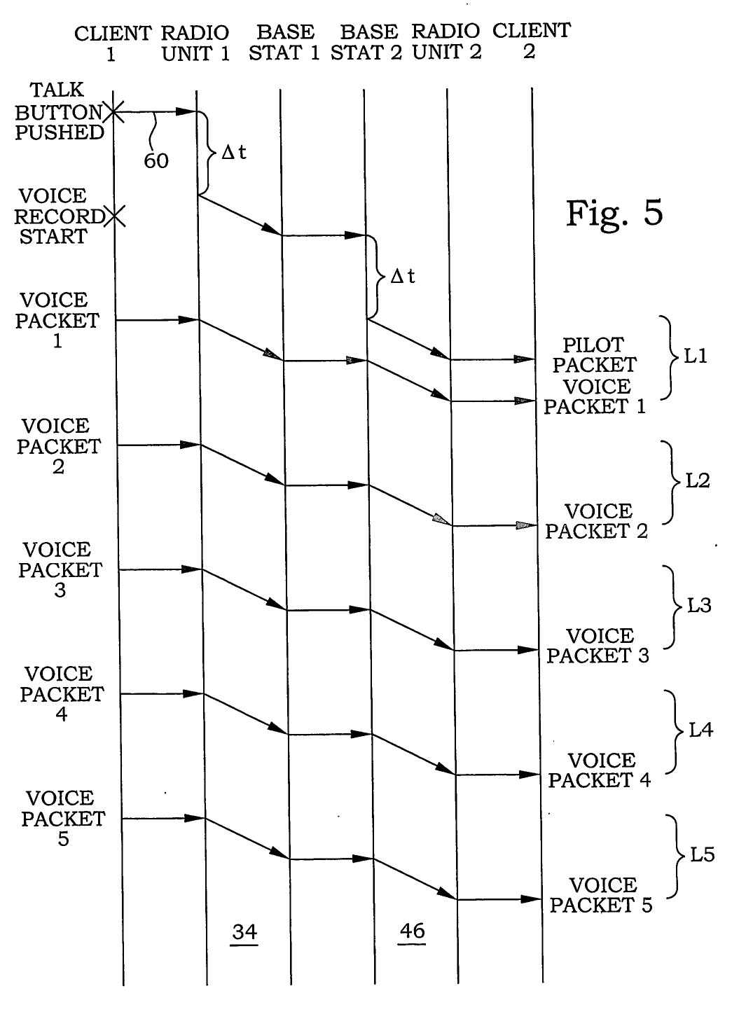

According to the present invention, a pilot packet is to be sent prior to the regular data packet stream in order to trig an early allocation of radio resources. A signalling diagram of such a situation is illustrated in FIG. 5. As soon as there is an indication that a voice stream is to take place within a few seconds, a pilot packet 60 can be created. The small pilot packet 60 shall be sent to the same receiver as the receiver of the voice stream. The small pilot packet 60 will be transported from the sender (radio unit 1) to the receiver (radio unit 2) a short time before the first IP packet carrying voice frames. While doing so, the pilot packet 60 will trig the allocation of radio resources 34, 46 on all the interfaces it crosses. When the IP packet carrying voice is transported along the same path a few hundred milliseconds later, the radio resources 34, 46 are already allocated according to conventional dynamic allocation schemes. The result is that the first packet will not suffer from the additional delay induced by the allocation of the radio resources. Instead, the first voice IP packet will have the same (small) latency as the subsequent voice packets. This enables the PTT application to operate at around 320 ms lower latency with the present invention than using prior art only.

Note that all times mentioned in the present description only are examples to illustrate the effect of the present invention in these particular embodiments, and should not restrict the scope of the patent protection.

The pilot packet can be designed in many different manners. It is, however, important that the pilot packet is enough simple to enable a fast sending, i.e. that no extensive data processing has to be performed prior to the sending. In a typical case, the pilot packet is empty, i.e. contains no data at all, or contains a smaller amount of dummy data. In order not to have to wait for the actual data to be sent, the content of the pilot packet is preferably independent of the content of the data subsequently to be sent. However, it would also be possible to let the pilot packet contain minor amounts of data associated with the data subsequently to be sent. It would also be possible to let the pilot packet comprise some general information about the session.

The preferred solution is to let the pushing of the Talk Button trigger the sending of the IP packet. This will occur typically a few hundred milliseconds prior to the point in time when the user starts to talk. From the start of talking, there is an additional 200 ms delay before the first IP packet carrying voice is transmitted. This time is used by the client to record 200 ms of speech (10 voice frames of 20 ms each) to put in the IP packet. The time from pushing the button until the sending of the first voice IP packet is long enough for the pilot packet to run through the system to trig the set-up of radio resources.

Another embodiment would be to let the onset of voice itself trig the sending of the pilot packet. In FIG. 5, this would correspond to the pilot packet signal trajectory starting at the cross “voice recording started”. Other possible trigging actions could for instance be that a certain application is opened or that an address book is consulted, for instance, activation of the Push-To-Talk application window in the client.

FIG. 6 illustrates a block scheme of an embodiment of a radio unit 20 according to the present invention. A microphone 23 records the voice of the client. A voice packet unit 25 transfers the analogue voice into digital voice packets that are forwarded to a transferring means 26. In the transferring means 26, the voice packets are processed into a proper format for being transmitted on a radio interface and resulting signals are forwarded to an antenna for transmission. The transferring means 26 also comprises necessary functionalities to allocated suitable radio resources according to conventional technology.

The radio unit 20 also comprises a talk button 21. When this talk button is pushed, voice is expected to occur within a short while. A detector 24 monitors the position or status of the talk button 21, and when the talk button 21 is pushed, the detector initiates a pilot packet unit 27 to create a pilot packet. The pilot packet is as soon as possible provided to the transferring means 26, for further delivery to the receiving radio unit.

As mentioned above, in another embodiment, the very onset of the talk may also be utilised for initiation of a pilot packet. In such a case, the detector 24 monitors the microphone 23, as indicated by the broken line 29. The pilot packet will than be created and transmitted during the time it takes to sample and packetise the speech.

In FIG. 1, a scenario having two radio interfaces is illustrated. However, the present invention may also be utilised also when only one radio interface is present, either at the sending or receiving side. Scenarios with more than two radio interfaces may also be feasible, depending on the nature of the wireless communications system. Also systems having wire or fibre links that use a scheme for dynamic allocation of transmission resource are of interest for implementing the present invention.

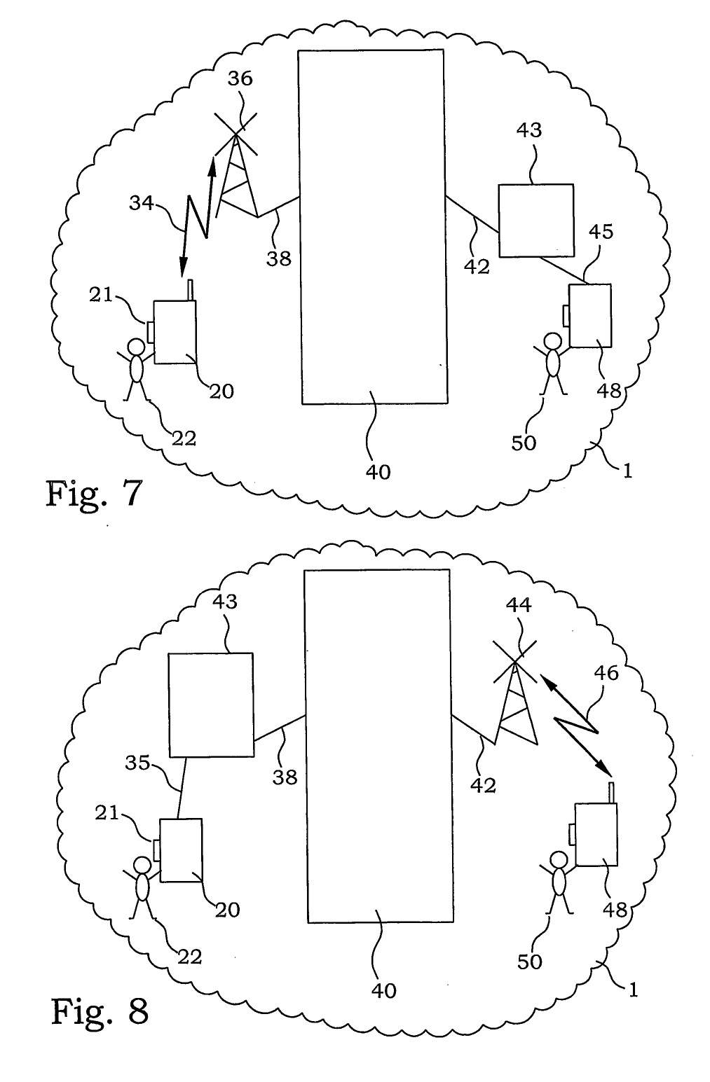

FIG. 7 illustrates a system, where the receiving client 50 has a terminal being connected to the core network 40 by wire or fibre 45. This can for instance be the case if the receiving client 50 is connected via a stationary communications network 43. The method for sending pilot packets will in such a system not differ from the earlier described cases. Moreover, the sending device 20 may still be configured as shown in FIG. 6.

FIG. 8 illustrates a system, where the sending client 50 has a terminal being connected to the core network 40 by wire or fibre 35. The method for sending pilot packets will in such a system not differ from the earlier described cases, except for that the pilot packet now initially is sent over a non-radio link 35. If the wire or fibre link 35 is a permanent link, the only resource allocation procedure will take place at the receiving side. However, if dynamic resource allocation is applied also in the wire or fibre link 35, resource allocation has to be performed also here, in analogy with the radio link case.

A sending device 20 suitable for the system of FIG. 8 is illustrated in FIG. 9. Almost every functionalities are similar to the embodiment illustrated in FIG. 6, however, the transferring means 26 is in this embodiment adapted for transmission of data packets onto a wire or fibre link 35.

Though the invention is described primarily in the context of PTT over GPRS and EDGE, it should be understood by anyone skilled in the art that the inventive technique is not restricted to this scenario. The inventive technique gives the same benefit in many other systems like W-CDMA, CDMA 1x, CDMA2000, possibly Bluetooth and more.

The invention can also be broadened towards other applications (in addition to PTT). One other example of an application where the present invention can be used is “Push To Video”, which works similar to “Push To Talk” but with the difference that a video sequence, rather than a voice stream, is sent when the push-button is pressed. Also here, a short pilot packet sent in response to the video button being pressed will reduce the latency. Furthermore, Voice over IP, on-line games and any application with latency requirements below 1000 ms could also potentially benefit from the present invention.

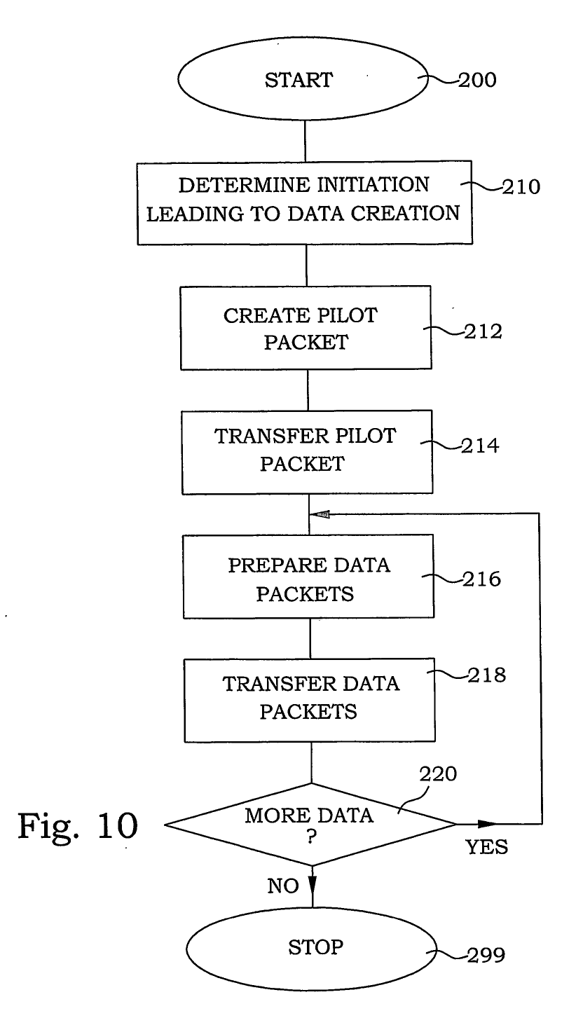

FIG. 10 illustrates a flow diagram of the main steps of an embodiment of a method according to the present invention. The procedure starts in step 200. In step 210, any initiation of a procedure that will lead to a near creation of data packets to be sent is detected. When such an initiation is detected, a pilot packet is created in step 212. In step 214, the pilot packet is transferred to the receiving unit along the same path as the coming data packets are to be transferred. Necessary communication links are thereby allocated along that path. In step 216, the data packets are prepared, and in step 218, the data packets are transferred along the same path as the pilot packet was transferred. If any further data packets are to be sent, as determined in step 220, the procedure returns to step 216. If the data stream is ended, the procedure will be ended in step 299.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined into other configurations, where technically possible. The scope of the present invention is, however, defined by the appended claims.

1-19. (canceled)

20. Method of transferring data packets in a communications system using a scheme for dynamic allocation of transmission resources, comprising the steps of:
preparing, in a data packet handling device, data packets to be transferred;
transferring said prepared data packets over at least one link using dynamic allocation;
detecting initiation of a procedure in said data packet handling device leading to subsequent creation of data for said data packets to be transferred;
creating, as a response of a detected initiation, a pilot packet; and
transferring said pilot packet, prior to completion of said preparing step for a first data packet and thereby prior to said transferring of said prepared data packets, over said at least one link, whereby transmission resources of said at least one link are allocated according to said scheme.

21. Method according to claim 20, wherein content of said pilot packet is independent of said data for said data packets.

22. Method according to claim 20, wherein content of said pilot packet comprises information about the communication session.

23. Method according to claim 20, wherein content of said pilot packet comprises an amount of data for said data packets that is smaller than the amount of data contained in the data packets.

24. Method according to claim 20, wherein said procedure leading to subsequent creation of data is a procedure selected from the list of:
Push To Talk;
Push To Video;
Voice over IP; and
interactive gaming.

25. Method according to claim 24, wherein said procedure leading to subsequent creation of data is Push To Talk.

26. Method according to claim 24, wherein said procedure leading to subsequent creation of data is Push To Video.

27. Method according to claim 25, wherein said initiation is associated with pressing a talk button.

28. Method according to claim 25, wherein said initiation is associated with an onset of speech recording.

29. Method according to claim 20, wherein said dynamic allocation of resources utilises a temporary block flow.

30. Method according to claim 20, wherein said at least one link is a radio link.

31. Device in a communications system having capability of transferring data packets using a scheme for dynamic allocation of transmission resources, comprising:
means for preparing data packets to be transferred;
transferring means, connected to said means for preparing data, said transferring means being arranged for transferring said prepared data packets over at least one link using dynamic allocation;
detecting means for detecting initiation of a procedure in said means for preparing data packets; and
means for creating a pilot packet as a response of a detected initiation, connected to said detecting means;
whereby said transferring means is further arranged for transferring said pilot packet, prior to completion of said preparing step for a first data packet and thereby prior to said transferring of said prepared data packets, over said at least one link, whereby transmission resources of said at least one link are allocated according to said scheme.

32. Device according to claim 31, wherein said means for creating a pilot packet is arranged to operate independent of said data for said data packets.

33. Device according to claim 31, wherein said means for creating a pilot packet is arranged to comprise information about the communication session in said pilot packet.

34. Device according to claim 31, wherein said means for creating a pilot packet is arranged to comprise an amount of data for said data packets that is smaller than the amount of data contained in the data packets in said pilot packet.

35. Device according to claim 31, wherein said communication system is a system selected from the list of:
GPRS;
EDGE;
W-CDMA;
CDMA 1x;
CDMA2000; and
Bluetooth.

36. Device according to claim 31, wherein said means for preparing data packets is comprised in an application selected from the list of:
Push To Talk;
Push To Video;
Voice over IP; and
interactive gaming.

37. Device according to claim 31, wherein said at least one link is a radio link.

38. Device according to claim 31, wherein said device is a mobile telephone.
